(19) United States
(12) Patent Application Publication
(10) Pub. No.: US 2026/0269447 A1
(43) Pub. Date: Sep. 10, 2026

(54) CROSS-TYPE DIRECTIONAL COUPLER

(71) Applicants: PABRAIN CO., LTD, Bucheon-si (KR); YTECH CO., LTD, Daejeon (KR)

(72) Inventors: Jong Jin PARK, Jeonju-si (KR); Young Hwan AHN, Seoul (KR)

(73) Assignees: PABRAIN CO., LTD, Bucheon-si (KR); YTECH CO., LTD, Daejeon (KR)

(21) Appl. No.: 19/671,116

(22) Filed: May 7, 2026

Related U.S. Application Data
(63) Continuation of application No. PCT/KR2024/017187, filed on Nov. 4, 2024.

(30) Foreign Application Priority Data
Nov. 7, 2023 (KR) 10-2023-0152390

(51) Int. Cl. H01P 5/18; H01P 1/18

(52) U.S. Cl. CPC H01P 5/186; H01P 1/184

(57) ABSTRACT

Disclosed is a cross-type directional coupler including: a ground plate electrically connected to a reference potential; first and second transmission lines disposed to face each other to be electromagnetically coupled by alternately crossing at a position spaced apart from the ground plate by a first distance in one direction and at a position spaced apart from the ground plate by a second distance greater than the first distance; and a dielectric having a predetermined dielectric constant and disposed between each of the first and second transmission lines and the ground plate to support each of the first transmission line, the second transmission line, and the ground plate. Accordingly, the directional coupler according to the present invention may have substantially identical impedance and excellent coupling characteristics and isolation, while reducing a thickness and a mounting space of the device and being usable at a lower frequency.

### CROSS-REFERENCE TO RELATED APPLICATION(S)

This application is a Continuation Application of International Application No. PCT/KR2024/017187, filed November 4, 2024, which claim for priority under 35 U.S.C. § 119 is made to Korean Patent Application No. 10-2023-0152390 filed on November 7, 2023 in the Korean Intellectual Property Office, the disclosure of which is incorporated herein by reference in its entirety.

### BACKGROUND

### 1. FIELD

The present invention relates to a cross-type directional coupler, and more particularly, to a cross-type directional coupler having substantially identical impedance and excellent coupling characteristics and isolation, while reducing a thickness and a mounting space of the device and being usable at a lower frequency.

### 2. DESCRIPTION OF RELATED ART

A directional coupler is a device used to distribute and output or combine input signals in measurement equipment and microsystems, and may be generally used as a half-power (3 dB) divider.

FIG. 1 is a view illustrating a structure of a conventional directional coupler, FIG. 2 is a view illustrating input and output power of each port of the directional coupler, and FIG. 3 is a view illustrating a lengthwise stacked structure of the conventional directional coupler.

Referring to FIG. 1, the conventional directional coupler may include first and second transmission lines 10 and 20 disposed in parallel with a second distance d2 minus a first distance d1 and having a dielectric 30 with a dielectric constant εᵣ therebetween, a first ground plate 40 parallel to a lower portion of the first transmission line 10 in a horizontal direction with the first distance d1 from the first transmission line 10, and a second ground plate 50 parallel to an upper portion of the second transmission line 20 in the horizontal direction with a third distance d3 from the second transmission line 20.

Accordingly, due to electromagnetic coupling between the first and second transmission lines 10 and 20, a part of radio frequency (RF) power input to the first transmission line 10 may be transferred to the second transmission line 20 or isolated from the second transmission line 20 depending on a coupling direction. Here, allowable power available for use of the directional coupler may be determined depending on heat diffusion performance of the dielectric 30 and a conductor included in the coupler.

Referring to FIG. 2, power incident on port 1 may exhibit a through power characteristic at port 2, and coupled power may appear at port 4, with a coupling amount being adjusted depending on a distance (the second distance d2 minus the first distance d1) between the first and second transmission lines 10 and 20 of FIG. 1 by electromagnetic coupling, and with a phase difference of 90 degrees from port 2. When all ports are assumed to have the same impedance, port 1 and port 3 may be completely isolated, and no power may be transferred from port 1 to port 3. Similarly, port 2 and port 4 may also be isolated.

Accordingly, to ensure an isolation characteristic, which is an extremely important characteristic of the directional coupler, it has been extremely important in the conventional art to allow all ports to have the same impedance characteristic. For all ports to exhibit the same impedance characteristic, a symmetrical structure is required in which a first line width W1 of the first transmission line 10, the first distance d1 between the first transmission line 10 and the first ground plate 40, and a first line length L1 of the first transmission line 10 are all identical to a second line width W2 of the second transmission line 20, a third distance d3 between the second transmission line 20 and the second ground plate 50, and a second line length L2 of the second transmission line 20, respectively.

For the symmetrical structure as described above, the conventional directional coupler is required to have the first and second transmission lines 10 and 20 disposed in parallel at the same distance from the first and second ground plates 40 and 50, respectively, in a length direction, as illustrated in FIG. 3.

However, it is not easy to manufacture the conventional directional coupler to have a perfectly symmetrical structure as described above. In addition, four conductor layers are stacked, resulting in an increased thickness of the device, and the first and second transmission lines 10 and 20 are embedded in the dielectric 30 having low thermal conductivity, resulting in poor heat dissipation characteristics.

In addition, the conventional directional coupler may require an increased mounting space for use at a low frequency.

### SUMMARY

The present invention has been made in an effort to solve the problems described above, and an object of the present invention is to provide a cross-type directional coupler having substantially identical impedance and excellent coupling characteristics and isolation, while reducing a thickness and a mounting space of the device and being usable at a lower frequency.

Objects of the present invention are not limited to the above-mentioned objects, and other objects that are not mentioned herein may be obviously understood by those skilled in the art to which the present invention pertains from the following description.

According to an aspect of the present invention, a cross-type directional coupler includes: a ground plate electrically connected to a reference potential; first and second transmission lines disposed to face each other to be electromagnetically coupled by alternately crossing at a position spaced apart from the ground plate by a first distance in one direction and at a position spaced apart from the ground plate by a second distance greater than the first distance, each end portion in a length direction forming each of first to fourth ports, and configured to transmit, with respect to input power of a signal input to any one of the first to fourth ports, through power, coupled power, and isolated power to remaining ports, respectively; and a dielectric having a predetermined dielectric constant and disposed between each of the first and second transmission lines and the ground plate to support each of the first transmission line, the second transmission line, and the ground plate.

Each of the first and second transmission lines may include one or more first layer lines disposed while being spaced apart from the ground plate by the first distance and one or more second layer lines disposed while being spaced apart from the ground plate by the second distance, and the first layer lines and the second layer lines of each of the first and second transmission lines may be alternately disposed.

The cross-type directional coupler may further include: a layer transition unit including a first transition bridge electrically connecting the first layer line and the second layer line of the first transmission line and a second transition bridge electrically connecting the first layer line and the second layer line of the second transmission line.

The first and second transmission lines may have a sum of lengths of the first layer lines of the first transmission line and a sum of lengths of the first layer lines of the second transmission line equal to each other, and a sum of lengths of the second layer lines of the first transmission line and a sum of lengths of the second layer lines of the second transmission line equal to each other.

A sum of lengths of the first layer lines and a sum of lengths of the second layer lines for each of the first and second transmission lines may be equal to each other.

The second layer line of each of the first and second transmission lines may have a line width greater than that of the first layer line.

According to an aspect of the present invention, a cross-type directional coupler includes: a ground plate electrically connected to a reference potential; first and second transmission lines disposed to face each other to be electromagnetically coupled by alternately crossing at a position spaced apart from the ground plate by a first distance in one direction and at a position spaced apart from the ground plate by a second distance greater than the first distance, and alternately crossing at a position spaced apart from the ground plate by a third distance in the other direction and at a position spaced apart from the ground plate by a fourth distance greater than the third distance, each end portion in a length direction forming each of first to fourth ports, and configured to transmit, with respect to input power of a signal input to any one of the first to fourth ports, through power, coupled power, and isolated power to remaining ports, respectively; and a dielectric having a predetermined dielectric constant and disposed between each of the first and second transmission lines and the ground plate to support each of the first transmission line, the second transmission line, and the ground plate.

Each of the first and second transmission lines may include one or more first layer lines disposed while being spaced apart from the ground plate by the first distance in one direction, one or more second layer lines disposed while being spaced apart from the ground plate by the second distance, one or more third layer lines disposed while being spaced apart from the ground plate by the third distance in the other direction, and one or more fourth layer lines disposed while being spaced apart from the ground plate by the fourth distance, the first layer lines and the second layer lines of each of the first and second transmission lines may be alternately disposed, and the third layer lines and the fourth layer lines of each of the first and second transmission lines may be alternately disposed.

The cross-type directional coupler may further include: a layer transition unit including a first transition bridge electrically connecting the first layer line and the second layer line of the first transmission line or electrically connecting the third layer line and the fourth layer line of the first transmission line, and a second transition bridge electrically connecting the first layer line and the second layer line of the second transmission line or electrically connecting the third layer line and the fourth layer line of the second transmission line.

Sums of lengths of the first layer lines for each of the first and second transmission lines may be equal to each other, sums of lengths of the second layer lines for each of the first and second transmission lines may be equal to each other, sums of lengths of the third layer lines for each of the first and second transmission lines may be equal to each other, and sums of lengths of the fourth layer lines for each of the first and second transmission lines may be equal to each other.

A sum of lengths of the first layer lines and a sum of lengths of the second layer lines for each of the first and second transmission lines may be equal to each other, and a sum of lengths of the third layer lines and a sum of lengths of the fourth layer lines for each of the first and second transmission lines may be equal to each other.

The second layer line of each of the first and second transmission lines may have a line width greater than that of the first layer line, and the fourth layer line of each of the first and second transmission lines may have a line width greater than that of the third layer line.

The cross-type directional coupler may further include: a first through bridge electrically connecting the other end portion of the first transmission line disposed on one side of the ground plate and the other end portion of the first transmission line disposed on the other side of the ground plate; and a second through bridge electrically connecting the other end portion of the second transmission line disposed on one side of the ground plate and the other end portion of the second transmission line disposed on the other side of the ground plate, wherein a through hole is formed in the ground plate to allow the first and second through bridges to pass through the ground plate while being spaced apart from the ground plate by a predetermined distance.

The cross-type directional coupler may further include: a phase adjustment line disposed at at least one end portion of each of the first and second transmission lines to adjust a phase or impedance at each of the first to fourth ports.

The cross-type directional coupler may further include: a protective dielectric disposed outside the first and second transmission lines and stacked to cover and protect the first and second transmission lines.

The cross-type directional coupler may further include: a shrinkage control unit including a plurality of conductor patterns disposed inside or outside the protective dielectric to induce uniform shrinkage during processing.

### BRIEF DESCRIPTION OF DRAWINGS

FIG. 1 is a view illustrating a structure of a conventional directional coupler.

FIG. 2 is a view illustrating input and output power of each port of the directional coupler.

FIG. 3 is a view illustrating a lengthwise stacked structure of the conventional directional coupler.

FIG. 4 is a view illustrating a lengthwise stacked structure of a cross-type directional coupler according to an embodiment of the present invention.

FIGS. 5A and 5B are views illustrating distributions of an electric field and a magnetic field in the conventional directional coupler and the directional coupler according to the present invention.

FIG. 6 is a view illustrating a configuration in which a phase adjustment line is added to the cross-type directional coupler according to the present invention.

FIGS. 7A and 7B are views illustrating a lengthwise stacked structure of a cross-type directional coupler according to another embodiment of the present invention.

FIG. 8 is a view illustrating an embodiment of the cross-type directional coupler according to the present invention.

FIGS. 9A and 9B are views illustrating S-parameter graphs of coupling performance and isolation performance of the cross-type directional coupler according to the present invention.

FIG. 10 is a view illustrating a configuration in which a protective dielectric for protecting a transmission line is added.

FIG. 11 is a view illustrating a configuration in which a shrinkage control unit for shrinkage control is added to the protective dielectric.

FIGS. 12A, 12B and 12C are views illustrating an exemplary pattern of the shrinkage control unit.

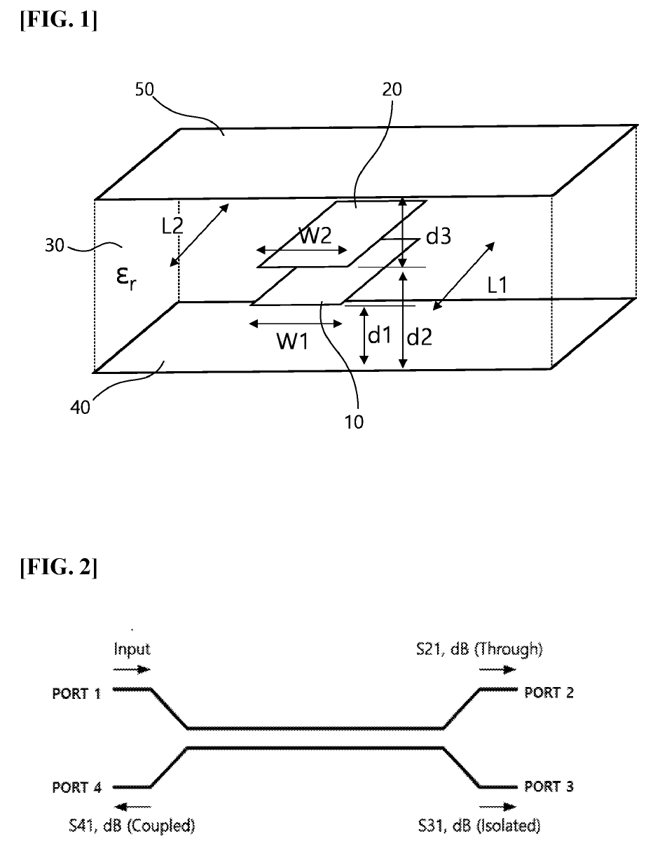

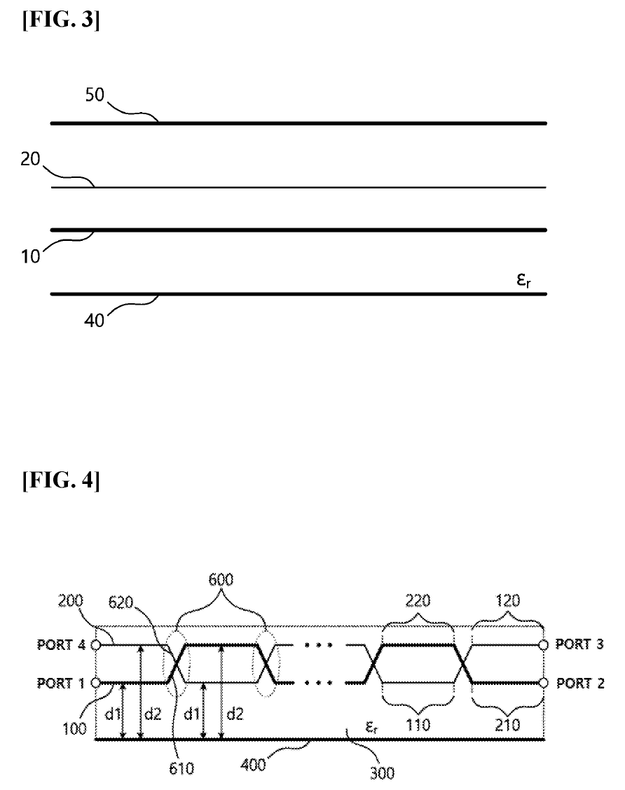

### DETAILED DESCRIPTION

Preferred embodiments of the present invention will be described in detail below with reference to the accompanying drawings. The following detailed description is only illustrative and merely illustrates a preferred embodiment of the present invention.

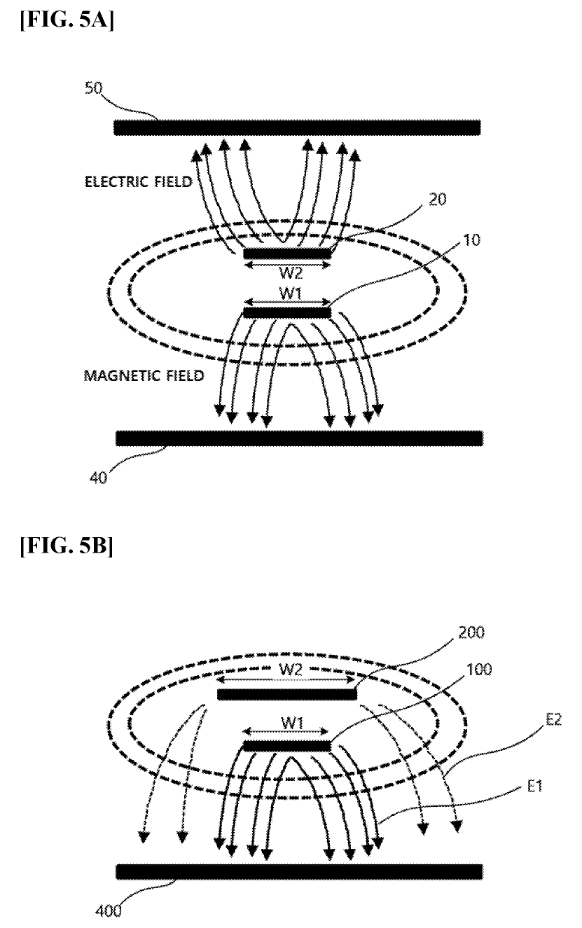

FIG. 4 is a view illustrating a lengthwise stacked structure of a cross-type directional coupler according to an embodiment of the present invention, and FIGS. 5A and 5B are views illustrating distributions of an electric field and a magnetic field in a conventional directional coupler and the directional coupler according to the present invention.

Referring to FIG. 4, the cross-type directional coupler according to an embodiment of the present invention may include: a ground plate 400 electrically connected to a reference potential; first and second transmission lines 100 and 200 disposed to face each other to be electromagnetically coupled by alternately crossing at a position spaced apart from the ground plate 400 by a first distance d1 in one direction and at a position spaced apart from the ground plate 400 by a second distance d2 greater than the first distance d1; and a dielectric 300 having a predetermined dielectric constant and disposed between each of the first and second transmission lines 100 and 200 and the ground plate 400 to support each of the first transmission line 100, the second transmission line 200, and the ground plate 400.

Here, each end portion of the first and second transmission lines 100 and 200 in a length direction may form each of first to fourth ports, and the first and second transmission lines 100 and 200 may transmit, with respect to input power of a signal input to any one of the first to fourth ports, through power, coupled power, and isolated power to remaining ports, respectively.

In addition, each of the first and second transmission lines 100 and 200 may include one or more first layer lines 110 and 210 disposed while being spaced apart from the ground plate 400 by the first distance d1 and one or more second layer lines 120 and 220 disposed while being spaced apart from the ground plate 400 by the second distance d2, and the first layer lines 110 and 210 and the second layer lines 120 and 220 of each of the first and second transmission lines 100 and 200 may be alternately disposed.

Through these configurations, through power and coupled power with respect to input power may be set to be greater than isolated power, and isolated power may ideally be set to be zero (0).

The first and second transmission lines 100 and 200 may be conductors to which signal power is input and through which the signal power is transmitted, and may be disposed in parallel while being spaced apart from each other by a predetermined distance. When a signal is input to one side end portion of either one of the first and second transmission lines 100 and 200, one side end portion of the corresponding transmission line may be an input port to which input power of the input signal is incident, and the other side end portion may be a through port at which a part of the input power passes and through power appears.

Here, one side end portion of the other one of the first and second transmission lines 100 and 200 may be a coupled port at which coupled power appears with a phase difference of 90 degrees with respect to the through port as a coupling amount is adjusted depending on a distance between the first and second transmission lines 100 and 200, that is, the second distance d2 minus the first distance d1, due to electromagnetic coupling, and the other side end portion may be an isolated port through which isolated power is transferred.

For example, as illustrated in FIG. 4, a line corresponding to a first port and/or a second port of the first transmission line 100 may be disposed while being spaced apart from the ground plate 400 by a first distance d1, and a line corresponding to a fourth port and/or a third port of the second transmission line 200 may be disposed above the ground plate 400 while being spaced apart from the ground plate 400 by a second distance d2, and an opposite configuration is also possible.

The first transmission line 100 may be disposed in the dielectric 300, and the second transmission line 200 may be disposed on an upper portion of the dielectric 300. However, when the dielectric 300 extends to an upper portion of the second transmission line 200 as illustrated in FIG. 4, the second transmission line 200 may also be disposed in the dielectric 300.

The ground plate 400 may be a conductive plate connected to a reference potential to have the reference potential electrically, and may be disposed below the first transmission line 100 while being spaced apart from the ground plate 400 by the first distance d1, and may be disposed below the dielectric 300 as illustrated in FIG. 4 or may be disposed in the dielectric 300 when the dielectric 300 extends to a lower portion of the ground plate 400.

In the present invention, the ground plate 400 may be disposed only on one side of the first transmission line 100 or the second transmission line 200, and the first and second transmission lines 100 and 200 may be disposed to face each other in respective arranged layers and may be alternately disposed in first and second layers spaced apart from the ground plate 400 by the first and second distances d1 and d2, respectively.

To this end, in an embodiment of the present invention, a layer transition unit 600 may include a first transition bridge 610 electrically connecting the first layer line 110 of the first transmission line 100 disposed in the first layer and the second layer line 120 of the first transmission line 100 disposed in the second layer, and a second transition bridge 620 electrically connecting the first layer line 210 of the second transmission line 200 disposed in the first layer and the second layer line 220 of the second transmission line 200 disposed in the second layer. Here, a plurality of first and second transition bridges 610 and 620 may be formed.

According to a size and a frequency of the directional coupler, one first transition bridge 610 and one second transition bridge 620 may be provided, respectively. However, when the first and second transmission lines 100 and 200 are configured in a helical or meander line structure by increasing integration density, the plurality of first and second transition bridges 610 and 620 may be provided.

The first and second transmission lines 100 and 200 used in the cross-type directional coupler according to the present invention have a strip structure. A characteristic impedance formula of a line varies according to a degree of coupling of the first and second transmission lines 100 and 200. However, the characteristic impedance of a line is basically known to decrease as a line width increases and to increase as a distance from the ground plate 400 increases (that is, as the distance becomes greater).

In order to obtain characteristics such as excellent isolation and coupling in the directional coupler, balance of impedance at all ports may be extremely important. The cross-type directional coupler according to the present invention may offset imbalance of impedance caused by the ground plate 400 being disposed only on one side of the first and second transmission lines 100 and 200 by alternately changing positions of the first and second transmission lines 100 and 200.

In order to effectively offset imbalance of impedance, the first and second transmission lines 100 and 200 of the cross-type directional coupler according to the present invention may have a sum of lengths of the first layer lines 110 of the first transmission line 100 and a sum of lengths of the first layer lines 210 of the second transmission line 200 equal to each other, and a sum of lengths of the second layer lines 120 of the first transmission line 100 and a sum of lengths of the second layer lines 220 of the second transmission line 200 equal to each other.

In addition, additionally or alternatively, a sum of lengths of the first layer lines 110 and 210 and a sum of lengths of the second layer lines 120 and 220 for each of the first and second transmission lines 100 and 200 may be equal to each other.

Accordingly, imbalance of impedance caused by different separation distances from the ground plate 400 may be effectively offset, thereby achieving excellent impedance balance and isolation.

In addition, the second layer lines 120 and 220 of each of the first and second transmission lines 100 and 200, which are disposed farther from the ground plate 400 than the first layer lines 110 and 210, may have a line width greater than that of the first layer lines 110 and 210.

Referring to FIG. 5A, in the conventional directional coupler, first and second ground plates 40 and 50 may be disposed while being spaced apart from the first and second transmission lines 10 and 20 by the same distance, respectively, and may thus have a uniform impedance due to symmetrical electric fields between the first and second transmission lines 10 and 20 and the first and second ground plates 40 and 50.

However, as illustrated in FIG. 5B, in the present invention, the first and second transmission lines 100 and 200 may share the ground plate 400. Accordingly, a difference may occur between a first electric field E1 between the ground plate 400 and the first transmission line 100 and a second electric field E2 between the ground plate 400 and the second transmission line 200 as distances from the ground plate 400 differ by the first and second distances d1 and d2. Therefore, in compensation for the difference, line widths at the first distance d1 and at the second distance d2 may be made different to achieve a specific impedance for implementing the directional coupler.

For example, when the second distance d2 is greater than the first distance d1, the second transmission line 200 may be disposed farther from the ground plate 400 than the first transmission line 100, and an impedance may thus be relatively high. Therefore, in compensation for the impedance, the second line width W2 of the second transmission line 200 may be made wider than the first line width W1 of the first transmission line 100.

In particular, in the cross-type directional coupler according to the present invention, upon passage of the first and second transmission lines 100 and 200 through the first and second transition bridges, a distance between the ground plate 400 and each line may vary between the first and second distances d1 and d2. Accordingly, the second layer lines 120 and 220 of each of the first and second transmission lines 100 and 200 having the second distance d2 from the ground plate 400 may have a line width greater than that of the first layer lines 110 and 210 having the smaller first distance d1.

The directional coupler may preferably have a phase difference of 90 degrees occurring between a through port and a coupled port, for example, between the second port and the fourth port or between the first port and the third port, and in the present invention, a phase error may occur due to a length difference between the first and second transmission lines 100 and 200 in a circuit layout when the layer transition unit 600 is implemented, and a correction means for the phase error may thus be required.

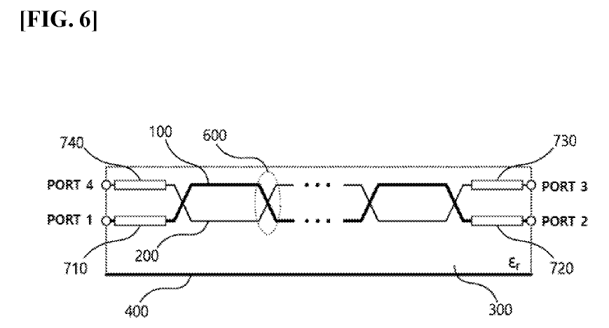

FIG. 6 is a view illustrating a configuration in which a phase adjustment line is added to the cross-type directional coupler according to the present invention.

Referring to FIG. 6, the cross-type directional coupler according to the present invention may include phase adjustment lines 710, 720, 730, and 740 disposed at at least one end portion of the first and second transmission lines 100 and 200 to correct a phase error caused by a length difference between the first and second transmission lines 100 and 200, that is, to adjust a phase or impedance at each of the first to fourth ports.

Accordingly, the first to fourth phase adjustment lines 710, 720, 730, and 740 connected from end portions of the first and second transmission lines 100 and 200 to the first to fourth ports may have appropriate lengths, and a length error, a phase error, and an impedance error may thus be corrected.

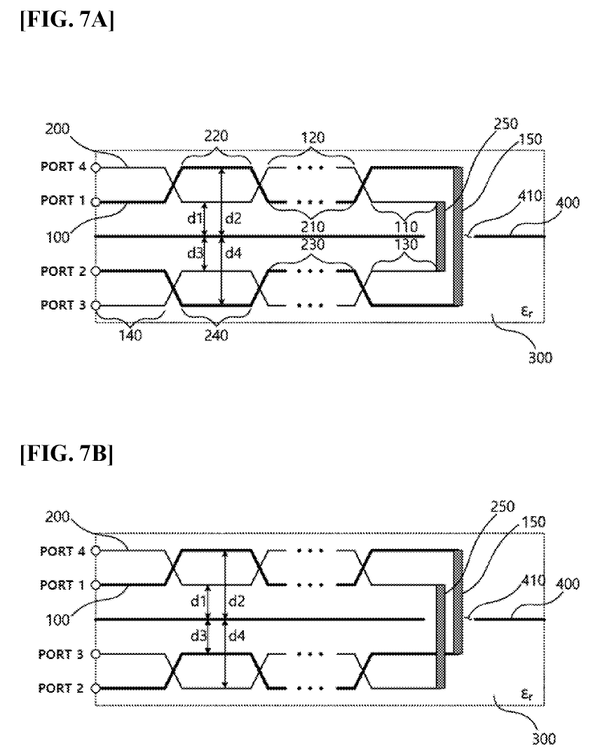

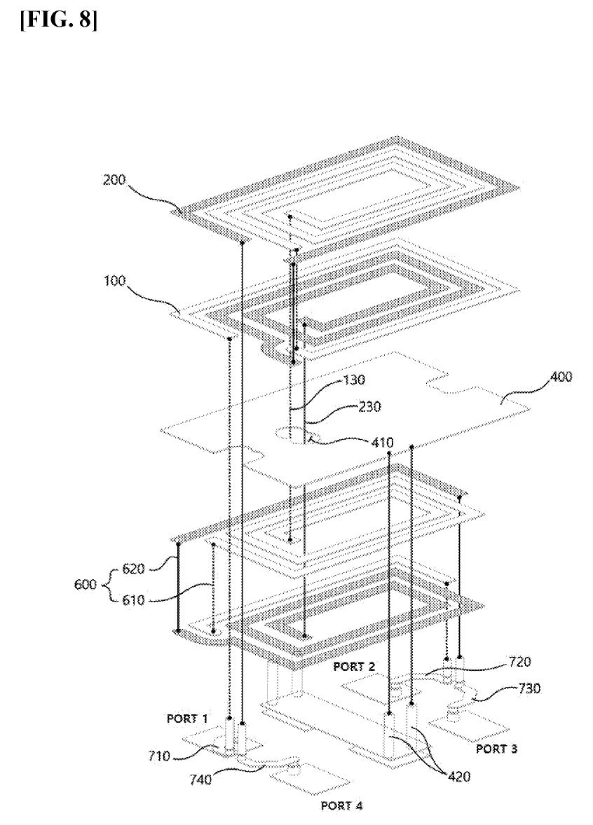

FIGS. 7A and 7B are views illustrating a lengthwise stacked structure of a cross-type directional coupler according to another embodiment of the present invention, and FIG. 8 is a view illustrating an embodiment of the cross-type directional coupler according to another embodiment of the present invention.

Referring to FIG. 7, the cross-type directional coupler according to another embodiment of the present invention may include: a ground plate 400 electrically connected to a reference potential; first and second transmission lines 100 and 200 disposed to face each other to be electromagnetically coupled by alternately crossing at a position spaced apart from the ground plate 400 by a first distance d1 in one direction and at a position spaced apart from the ground plate 400 by a second distance d2 greater than the first distance d1, and alternately crossing at a position spaced apart from the ground plate 400 by a third distance d3 in the other direction and at a position spaced apart from the ground plate 400 by a fourth distance d4 greater than the third distance d3; and a dielectric 300 having a predetermined dielectric constant and disposed between each of the first and second transmission lines 100 and 200 and the ground plate 400 to support each of the first transmission line 100, the second transmission line 200, and the ground plate 400.

Here, each one end portion of the first and second transmission lines 100 and 200 in a length direction may form each of first to fourth ports, and the first and second transmission lines 100 and 200 may transmit, with respect to input power of a signal input to any one of the first to fourth ports, through power, coupled power, and isolated power to remaining ports, respectively.

Through these configurations, through power and coupled power with respect to input power may be set to be greater than isolated power, and isolated power may ideally be set to be zero (0).

In another embodiment of the present invention, each of the first and second transmission lines 100 and 200 may include one or more first layer lines 110 and 210 disposed while being spaced apart from the ground plate 400 by the first distance d1 in one direction and one or more second layer lines 120 and 220 disposed while being spaced apart from the ground plate 400 by the second distance d2, and may further include one or more third layer lines 130 and 230 disposed while being spaced apart from the ground plate 400 by the third distance d3 in the other direction opposite to one direction and one or more fourth layer lines 140 and 240 disposed while being spaced apart from the ground plate 400 by the fourth distance d4. Here, the first layer lines 110 and 210 and the second layer lines 120 and 220 of each of the first and second transmission lines 100 and 200 may be alternately disposed, and the third layer lines 130 and 230 and the fourth layer lines 140 and 240 of each of the first and second transmission lines 100 and 200 may be alternately disposed.

Here, it is preferable that the first and second transmission lines 100 and 200 are symmetrically configured with respect to the ground plate 400 by setting the first and third distances d1 and d3 to be equal to each other and the second and fourth distances d2 and d4 to be equal to each other. However, a case in which the first and third distances d1 and d3 are different from each other or a case in which the second and fourth distances d2 and d4 are different from each other is not excluded.

In another embodiment of the present invention, the first transmission line 100 and the second transmission line 200 may extend to both surfaces of the ground plate 400, and the first and second transmission lines 100 and 200 may be disposed to face each other in respective arranged layers and may be alternately disposed in first and second layers spaced apart from the ground plate 400 by the first and second distances d1 and d2, respectively, in one direction, and alternately disposed in third and fourth layers spaced apart from the ground plate 400 by the third and fourth distances d3 and d4, respectively, in the other direction.

To this end, in another embodiment of the present invention, a layer transition unit 600 may include a first transition bridge 610 electrically connecting the first layer line 110 of the first transmission line 100 disposed in the first layer and the second layer line 120 of the first transmission line 100 disposed in the second layer and electrically connecting the third layer line 130 of the first transmission line 100 disposed in the third layer and the fourth layer line 140 of the first transmission line 100 disposed in the fourth layer, and a second transition bridge 620 electrically connecting the first layer line 210 of the second transmission line 200 disposed in the first layer and the second layer line 220 of the second transmission line 200 disposed in the second layer and electrically connecting the third layer line 230 of the second transmission line 200 disposed in the third layer and the fourth layer line 240 of the second transmission line 200 disposed in the fourth layer. Here, a plurality of first and second transition bridges 610 and 620 may be formed.

In order to effectively offset imbalance of impedance occurring in each transmission line, the first and second transmission lines 100 and 200 of the cross-type directional coupler according to another embodiment of the present invention may have sums of lengths of the first layer lines 110 and 210 for each of the first and second transmission lines 100 and 200 equal to each other, sums of lengths of the second layer lines 120 and 220 for each of the first and second transmission lines 100 and 200 equal to each other, sums of lengths of the third layer lines 130 and 230 for each of the first and second transmission lines 100 and 200 equal to each other, and sums of lengths of the fourth layer lines 140 and 240 for each of the first and second transmission lines 100 and 200 equal to each other.

In addition, additionally or alternatively, a sum of lengths of the first layer lines 110 and 210 and a sum of lengths of the second layer lines 120 and 220 for each of the first and second transmission lines 100 and 200 may be equal to each other, and a sum of lengths of the third layer lines 130 and 230 and a sum of lengths of the fourth layer lines 140 and 240 for each of the first and second transmission lines 100 and 200 may be equal to each other.

Accordingly, imbalance of impedance caused by different separation distances from the ground plate 400 may be effectively offset, thereby achieving excellent impedance balance and isolation. In addition, similarly to an embodiment of the present invention, the second layer lines 120 and 220 and the fourth layer lines 140 and 240 of each of the first and second transmission lines 100 and 200, which are disposed farther from the ground plate 400 than the first layer lines 110 and 210, may have line widths greater than those of the first layer lines 110 and 210 and the third layer lines 130 and 230.

Referring to FIGS. 7 and 8, in another embodiment of the present invention, in order for the first and second transmission lines 100 and 200 to extend from one side surface of the ground plate 400 to the other side surface thereof, the cross-type directional coupler may include a first through bridge 150 electrically connecting the other end portion of the first transmission line 100 disposed on one side of the ground plate 400 and the other end portion of the first transmission line 100 disposed on the other side of the ground plate 400, and a second through bridge 250 electrically connecting the other end portion of the second transmission line 200 disposed on one side of the ground plate 400 and the other end portion of the second transmission line 200 disposed on the other side of the ground plate 400. To this end, a through hole 410 may be formed in the ground plate 400 to allow the first and second through bridges 150 and 250 to pass through the ground plate 400 while being spaced apart from the ground plate 400 by a predetermined distance.

In addition, as illustrated in FIG. 7A, the first and second transmission lines 100 and 200 according to another embodiment of the present invention may have a symmetrical structure in which the first layer lines 110 and 210 and the third layer lines are connected and the second layer lines 120 and 220 and the fourth layer lines 140 and 240 are connected through the first and second through bridges 150 and 250. Alternatively, as illustrated in FIG. 7B, the first and second transmission lines 100 and 200 according to another embodiment may have an asymmetrical structure in which the first layer lines 110 and 210 and the fourth layer lines are connected and the second layer lines 120 and 220 and the third layer lines 130 and 230 are connected.

In another embodiment of the present invention, unlike an embodiment in which the first and second transmission lines 100 and 200 are disposed only on one side of the ground plate 400, the first and second transmission lines 100 and 200 may be configured in two or more stages disposed on both surfaces of the ground plate 400, that is, on both the one side and the other side of the ground plate. Accordingly, an effective length of the transmission line may increase even with the same size, thereby reducing a mounting area and further lowering a frequency of a use band of the directional coupler.

In addition, in the conventional directional coupler, at least three ground plates 400 may be required for this arrangement, whereas in the cross-type directional coupler according to the present invention, the ground plate 400 may be implemented using only one ground plate, thereby reducing not only a thickness but also drastically reducing a material cost.

Referring to FIG. 8, the layer transition unit 600 may be implemented using a via hole, the layer transition unit 600 including the first and second transition bridges 610 and 620 connecting the first layer lines 110 and 210 and the second layer lines 120 and 220 of the first and second transmission lines 100 and 200, and connecting the third layer lines 130 and 230 and the fourth layer lines 140 and 240 of the first and second transmission lines 100 and 200.

Furthermore, the first and second through bridges 150 and 250 may also be implemented using a via hole, the first and second through bridges 150 and 250 connecting the first layer lines 110 and 210 and the second layer lines 120 and 220, and connecting the third layer lines 130 and 230 and the fourth layer lines 140 and 240 through the through hole 410 of the ground plate 400.

A metal pad forming the first and fourth ports may be formed on a lower end portion of the cross-type directional coupler according to the present invention, and each port and the first and second transmission lines 100 and 200 may be connected by a via hole. Here, first to fourth phase adjustment lines 710, 720, 730, and 740 capable of adjusting a phase or impedance at each of the first to fourth ports may be formed between each port and the via hole to correct a phase error caused by a length difference between the first and second transmission lines 100 and 200.

In addition, a ground pad electrically connected to a reference potential may be formed on a lower end portion of the cross-type directional coupler according to the present invention, and a ground via hole 420 electrically connecting the ground pad and the ground plate 400 may be formed to set the reference potential at the ground plate 400.

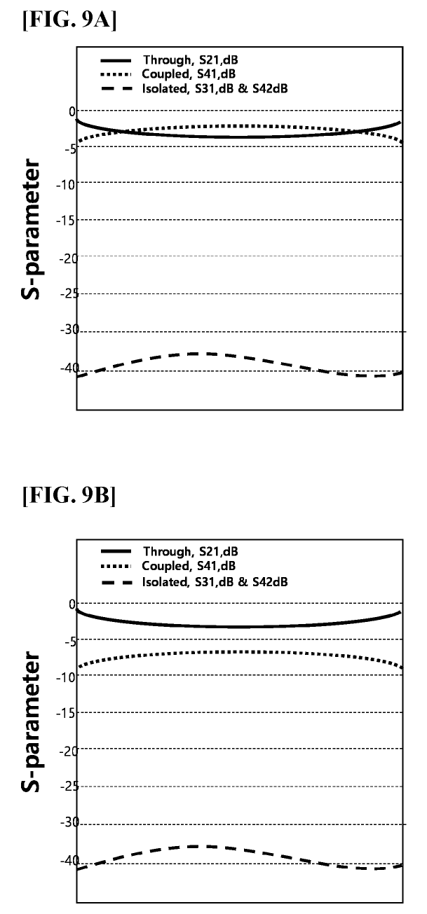

FIGS. 9A and 9B are views illustrating S-parameter graphs of coupling performance and isolation performance of the cross-type directional coupler according to the present invention.

The graphs illustrated in FIGS. 9A and 9B show examples of coupling performance (Coupled, S41 (dB)) when a distance between the first and second transmission lines 100 and 200, that is, the second distance d2 minus the first distance d1, is small in FIG. 9A and when the distance is large in FIG. 9B in the directional coupler according to the present invention.

Referring to FIGS. 9A and 9B, in the cross-type directional coupler according to the present invention, it can be seen that as the first and second transmission lines 100 and 200 become farther apart, an amount electromagnetically coupled decreases, thereby adjusting a coupling amount, and electrical isolation performance of -30 dB or more is achieved due to characteristic impedance balance between ports obtained through the cross-type transmission line structure of the present invention.

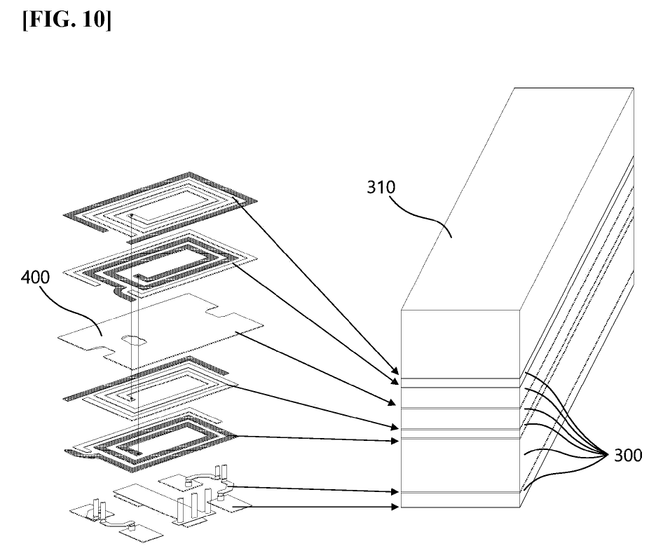

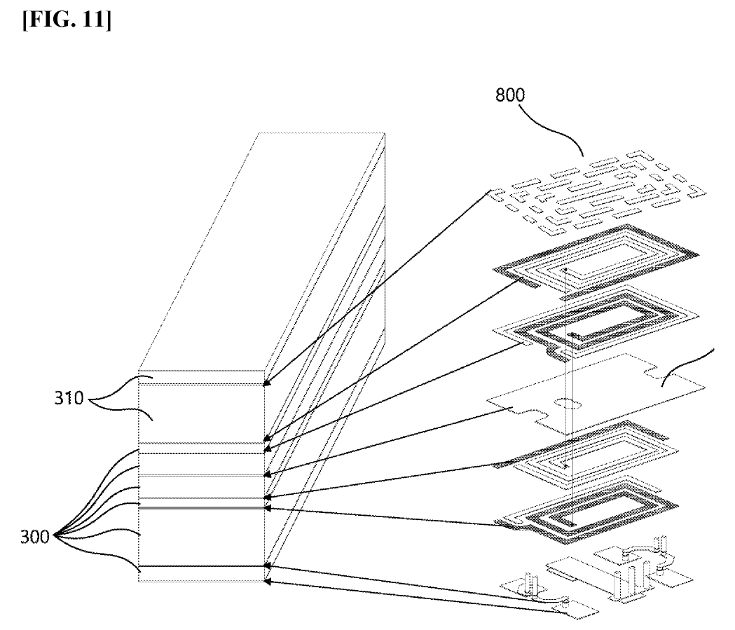

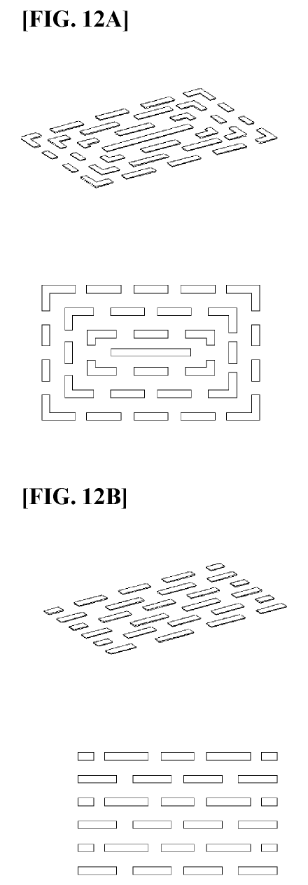

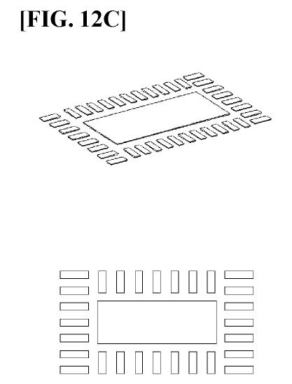

FIG. 10 is a view illustrating a configuration in which a protective dielectric 310 for protecting the transmission line is added, FIG. 11 is a view illustrating a configuration in which a shrinkage control unit 800 for shrinkage control is added to the protective dielectric 310, and FIGS. 12A, 12B and 12C are views illustrating an exemplary pattern of the shrinkage control unit 800.

Referring to FIG. 10, the cross-type directional coupler according to the present invention may further include the protective dielectric 310 disposed outside the first and second transmission lines 100 and 200 and stacked to cover and protect the first and second transmission lines 100 and 200.

The protective dielectric 310 for protecting the first and second transmission lines 100 and 200 may be required to obtain stable electromagnetic coupling performance by protecting an uppermost transmission line layer from the outside and securing dielectric layers surrounding the first and second transmission lines 100 and 200 above and below. Here, the protective dielectric 310 may be integrally formed with the dielectric 300 by extension of the existing dielectric 300. However, the protective dielectric 310 may also be a dielectric layer separate therefrom.

However, in a structure in which the protective dielectric 310 is formed in this manner, shrinkage may occur in x, y, and z directions when the directional coupler is implemented using low temperature co-firing ceramic (LTCC). Here, a shrinkage rate may vary for each region based on a distribution of transmission lines or electrodes, and warpage may thus occur in the directional coupler product. The warpage may cause poor mounting quality when the directional coupler product is surface-mounted (SMT).

In order to solve this problem, as illustrated in FIG. 11, the cross-type directional coupler according to the present invention may further include the shrinkage control unit 800 disposed inside or outside the protective dielectric 310 to induce uniform shrinkage during processing.

The shrinkage control unit 800 may include a plurality of conductor patterns such as those exemplified in FIGS. 12A to 12C. The plurality of conductor patterns may be regularly or irregularly formed in terms of shape, size, and arrangement direction, and shapes and arrangement methods thereof may be variously implemented.

The conductor patterns of the shrinkage control unit 800 may be positioned on an uppermost layer of lines included in the transmission lines and may act to reduce warpage during low-temperature co-firing by having a shrinkage rate similar to that in a case where a line layer or a pad electrode layer shrinks. Here, it is preferable that the conductor patterns of the shrinkage control unit 800 include two or more fragmented electrode patterns to minimize an effect on electromagnetic coupling of the transmission lines, as illustrated in FIGS. 12A to 12C.

Through the above-described configuration, the cross-type directional coupler according to the present invention may have substantially identical impedance and excellent coupling characteristics and isolation, while reducing a thickness and a mounting space of the directional coupler device and being usable at a lower frequency.

As set forth above, the cross-type directional coupler according to the present invention may have substantially identical impedances and excellent coupling characteristics and isolation.

In addition, the cross-type directional coupler according to the present invention may reduce a thickness and a mounting space of the device and may be usable at a lower frequency.

Hereinabove, the present invention is described and illustrated based on the preferred embodiments illustrating a principle of the present invention. However, the present invention is not limited to the configuration and operation shown and described as described above. It should be understood that the embodiments described hereinabove are illustrative rather than being restrictive in all aspects. It should be understood that the scope of the present invention is defined by the append portioned claims, and all modifications and alternations derived from the meaning and scope of the claims and their equivalents are included in the scope of the present invention.

What is claimed is:

1. A cross-type directional coupler comprising:
a ground plate electrically connected to a reference potential;
first and second transmission lines disposed to face each other to be electromagnetically coupled by alternately crossing at a position spaced apart from the ground plate by a first distance in one direction and at a position spaced apart from the ground plate by a second distance greater than the first distance, each end portion in a length direction forming each of first to fourth ports, and configured to transmit, with respect to input power of a signal input to any one of the first to fourth ports, through power, coupled power, and isolated power to remaining ports, respectively; and
a dielectric having a predetermined dielectric constant and disposed between each of the first and second transmission lines and the ground plate to support each of the first transmission line, the second transmission line, and the ground plate.

2. The cross-type directional coupler of claim 1, wherein each of the first and second transmission lines includes one or more first layer lines disposed while being spaced apart from the ground plate by the first distance and one or more second layer lines disposed while being spaced apart from the ground plate by the second distance, and
the first layer lines and the second layer lines of each of the first and second transmission lines are alternately disposed.

3. The cross-type directional coupler of claim 2, further comprising:
a layer transition unit including a first transition bridge electrically connecting the first layer line and the second layer line of the first transmission line and a second transition bridge electrically connecting the first layer line and the second layer line of the second transmission line.

4. The cross-type directional coupler of claim 2, wherein the first and second transmission lines have a sum of lengths of the first layer lines of the first transmission line and a sum of lengths of the first layer lines of the second transmission line equal to each other, and
a sum of lengths of the second layer lines of the first transmission line and a sum of lengths of the second layer lines of the second transmission line equal to each other.

5. The cross-type directional coupler of claim 2, wherein a sum of lengths of the first layer lines and a sum of lengths of the second layer lines for each of the first and second transmission lines are equal to each other.

6. The cross-type directional coupler of claim 2, wherein the second layer line of each of the first and second transmission lines has a line width greater than that of the first layer line.

7. A cross-type directional coupler comprising:
a ground plate electrically connected to a reference potential;
first and second transmission lines disposed to face each other to be electromagnetically coupled by alternately crossing at a position spaced apart from the ground plate by a first distance in one direction and at a position spaced apart from the ground plate by a second distance greater than the first distance, and alternately crossing at a position spaced apart from the ground plate by a third distance in the other direction and at a position spaced apart from the ground plate by a fourth distance greater than the third distance, each end portion in a length direction forming each of first to fourth ports, and configured to transmit, with respect to input power of a signal input to any one of the first to fourth ports, through power, coupled power, and isolated power to remaining ports, respectively; and
a dielectric having a predetermined dielectric constant and disposed between each of the first and second transmission lines and the ground plate to support each of the first transmission line, the second transmission line, and the ground plate.

8. The cross-type directional coupler of claim 7, wherein each of the first and second transmission lines includes one or more first layer lines disposed while being spaced apart from the ground plate by the first distance in one direction, one or more second layer lines disposed while being spaced apart from the ground plate by the second distance, one or more third layer lines disposed while being spaced apart from the ground plate by the third distance in the other direction, and one or more fourth layer lines disposed while being spaced apart from the ground plate by the fourth distance,
the first layer lines and the second layer lines of each of the first and second transmission lines are alternately disposed, and
the third layer lines and the fourth layer lines of each of the first and second transmission lines are alternately disposed.

9. The cross-type directional coupler of claim 8, further comprising:
a layer transition unit including a first transition bridge electrically connecting the first layer line and the second layer line of the first transmission line or electrically connecting the third layer line and the fourth layer line of the first transmission line, and a second transition bridge electrically connecting the first layer line and the second layer line of the second transmission line or electrically connecting the third layer line and the fourth layer line of the second transmission line.

10. The cross-type directional coupler of claim 8, wherein sums of lengths of the first layer lines for each of the first and second transmission lines are equal to each other,
sums of lengths of the second layer lines for each of the first and second transmission lines are equal to each other,
sums of lengths of the third layer lines for each of the first and second transmission lines are equal to each other, and
sums of lengths of the fourth layer lines for each of the first and second transmission lines are equal to each other.

11. The cross-type directional coupler of claim 8, wherein a sum of lengths of the first layer lines and a sum of lengths of the second layer lines for each of the first and second transmission lines are equal to each other, and
a sum of lengths of the third layer lines and a sum of lengths of the fourth layer lines for each of the first and second transmission lines are equal to each other.

12. The cross-type directional coupler of claim 8, wherein the second layer line of each of the first and second transmission lines has a line width greater than that of the first layer line, and
the fourth layer line of each of the first and second transmission lines has a line width greater than that of the third layer line.

13. The cross-type directional coupler of claim 7, further comprising:
a first through bridge electrically connecting the other end portion of the first transmission line disposed on one side of the ground plate and the other end portion of the first transmission line disposed on the other side of the ground plate; and
a second through bridge electrically connecting the other end portion of the second transmission line disposed on one side of the ground plate and the other end portion of the second transmission line disposed on the other side of the ground plate,
wherein a through hole is formed in the ground plate to allow the first and second through bridges to pass through the ground plate while being spaced apart from the ground plate by a predetermined distance.

14. The cross-type directional coupler of claim 7, further comprising:
a phase adjustment line disposed at at least one end portion of each of the first and second transmission lines to adjust a phase or impedance at each of the first to fourth ports.

15. The cross-type directional coupler of claim 7, further comprising:
a protective dielectric disposed outside the first and second transmission lines and stacked to cover and protect the first and second transmission lines.

16. The cross-type directional coupler of claim 15, further comprising:
a shrinkage control unit including a plurality of conductor patterns disposed inside or outside the protective dielectric to induce uniform shrinkage during processing.

17. The cross-type directional coupler of claim 1, further comprising:
a phase adjustment line disposed at at least one end portion of each of the first and second transmission lines to adjust a phase or impedance at each of the first to fourth ports.

18. The cross-type directional coupler of claim 1, further comprising:
a protective dielectric disposed outside the first and second transmission lines and stacked to cover and protect the first and second transmission lines.
